(19) United States
(12) Patent Application Publication
(10) Pub. No.: US 2010/0095508 A1
(43) Pub. Date: Apr. 22, 2010

(54) SPIRALLY WELDED CONICAL TOWER SECTIONS

(75) Inventors: Patrick Wahlen, Jupiter, FL (US); Elmar Schwill, Essen (DE); Teresa Melfi, Kirtland, OH (US)

Correspondence Address: PAUL, HASTINGS, JANOFSKY & WALKER LLP, 875 15th Street, NW, Washington, DC, 20005, US

(73) Assignee: LINCOLN GLOBAL, INC., City of Industry, CA (US)

(21) Appl. No.: 12/255,984

(22) Filed: Oct. 22, 2008

(51) Int. Cl. B23P 11/00; B23K 31/02; H05B 1/00

(52) U.S. Cl. 29/428; 228/158; 219/162

(57) ABSTRACT

An apparatus and method for manufacturing conical tower sections is provided in which a plate member is continuously rolled such that a conical shape is imparted on the tower section. A plate is rolled such that a seam angle is continuously changed to effect a diameter change in the tower section to create conical shape.

### BACKGROUND OF THE INVENTION

1. Field of the Invention

Devices, systems, and methods consistent with the invention relate to a method and apparatus for welding conical sections, including conical tower sections.

2. Description of the Related Art

Currently, the assembly and manufacture of metal conical towers is done by connecting conical sections or cans. These conical towers are commonly used for wind tower generators, which generate electric power from wind, and are typically in excess of 60 meters in height. Because the overall size of the towers is very large and require significant welding resources, they are manufactured remotely from the ultimate installation site. However, the entire conical tower cannot be assembled and transported to the installation site because of shipping restraints from the manufacturing location to the installation site. Because of these restraints, a series of conical cans are welded together to form a tower section having a height of about 20 to 30 meters, which can be shipped. Thus, to assemble a complete tower, three (3) 20 to 30 meter long sections must be manufactured from a series of individual conical cans and then shipped to the ultimate installation site of the tower. This process typically requires one week to manufacture the components for a single wind generator tower.

Additionally, current manufacturing of the conical cans involves generating substantial material waste and delay due to the complex shapes that must be manufactured prior to making the conical cans. This is exhibited in FIGS. 1A and 1B. FIG. 1B diagrammatically illustrates a conical can 100 as described above. A typical conical tower section is made up of a number of conical cans 100, each having a varying diameter so that a tower section can be formed. Each of the cans 100 is made from a metal (for example, steel) plate section 101 which is rolled and welded at a seam 105 to form a conical can shape as shown. However, as shown in FIG. 1A the plate section 101 needed to form the can 100 is not rectangular. As shown in FIG. 1A plate 101 (when lying flat) has two curved sides (top and bottom as shown) and two angled sides (the sides as shown). This shape is needed to result in a finished conical form as shown in FIG. 1B. The plate 101 is formed from rectangular sheet stock 103, as shown in FIG. 1A. This generates substantial waste material (approximately 10 to 15%). These additional machining and forming steps also increases labor time and costs.

With the increasing interest in alternative energy generation there is an increasing interest in wind tower generators. Accordingly, there exists a need to more effectively and efficiently manufacture conical towers.

### BRIEF SUMMARY OF THE INVENTION

A method of manufacturing a conically shaped structure which includes providing a plate to a rolling device and rolling the plate with the rolling device in a helical pattern having seam. The method further includes changing an angle of the seam to roll the plate into a conical shape and then welding the seam.

### BRIEF DESCRIPTION OF THE DRAWINGS

The above and/or other aspects of the invention will be more apparent by describing in detail exemplary embodiments of the invention with reference to the accompanying drawings, in which:

FIG. 1A illustrates a diagrammatical representation of a plate used to manufacture a conical can;

FIG. 1B illustrates a diagrammatical representation of a conical can made from the plate of FIG. 1A;

FIG. 2A illustrates a diagrammatical representation of a conical tower section in accordance with an embodiment of the present invention;

FIG. 2B illustrates a diagrammatical representation of a conical tower section in accordance with another embodiment of the present invention;

FIG. 2C illustrates a diagrammatical representation of a conical tower section in accordance with a further embodiment of the present invention;

FIG. 2D illustrates a diagrammatical representation of a conical tower in accordance with an embodiment of the present invention; and

FIG. 3 illustrates a diagrammatical representation of a method of manufacturing a conical tower section in accordance with an embodiment of the present invention.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

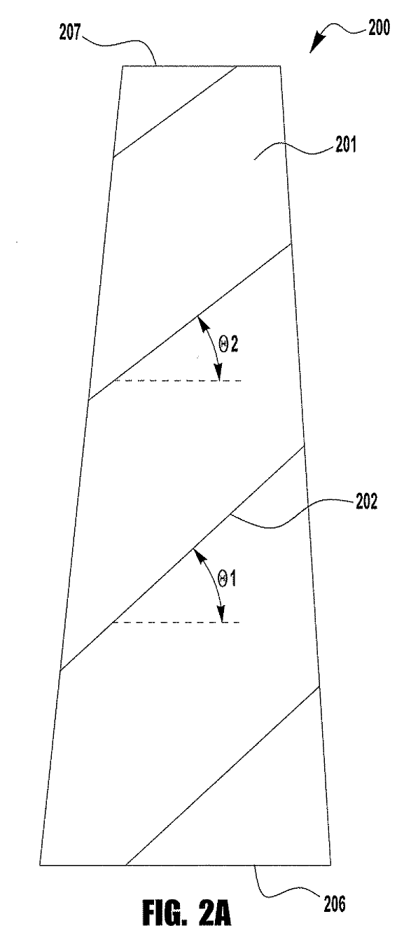

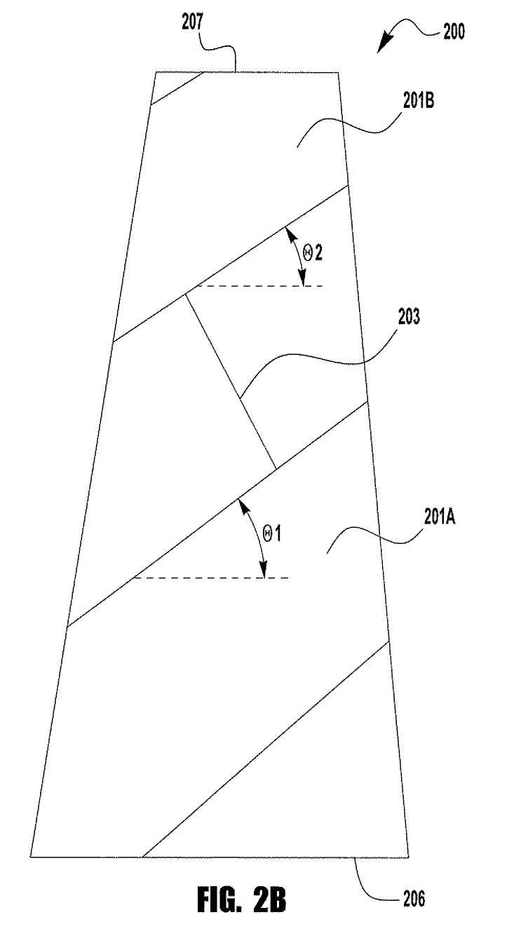

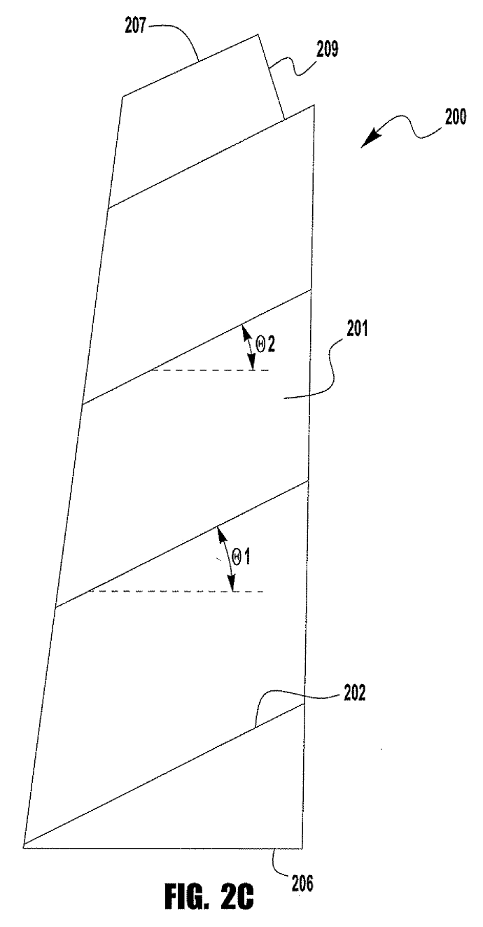

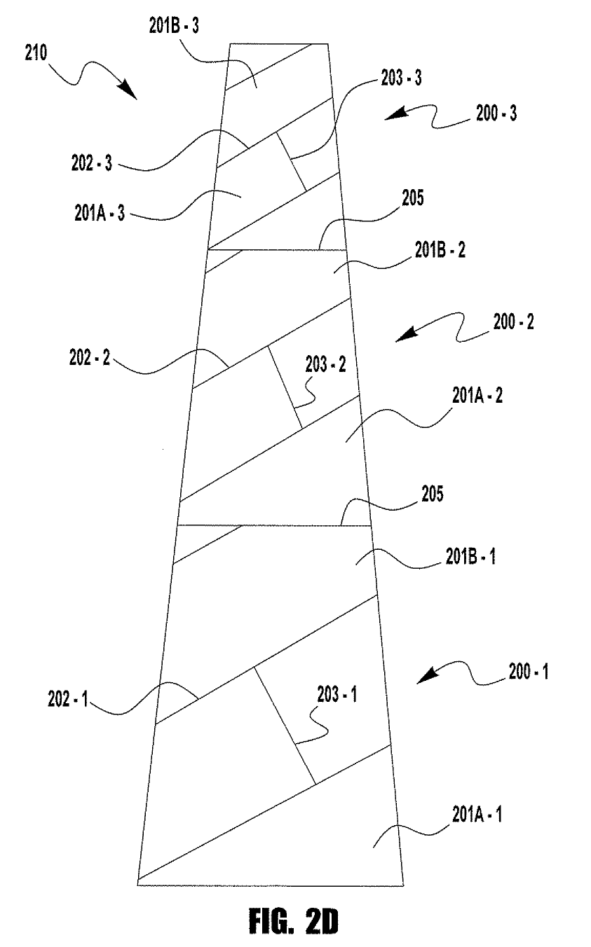

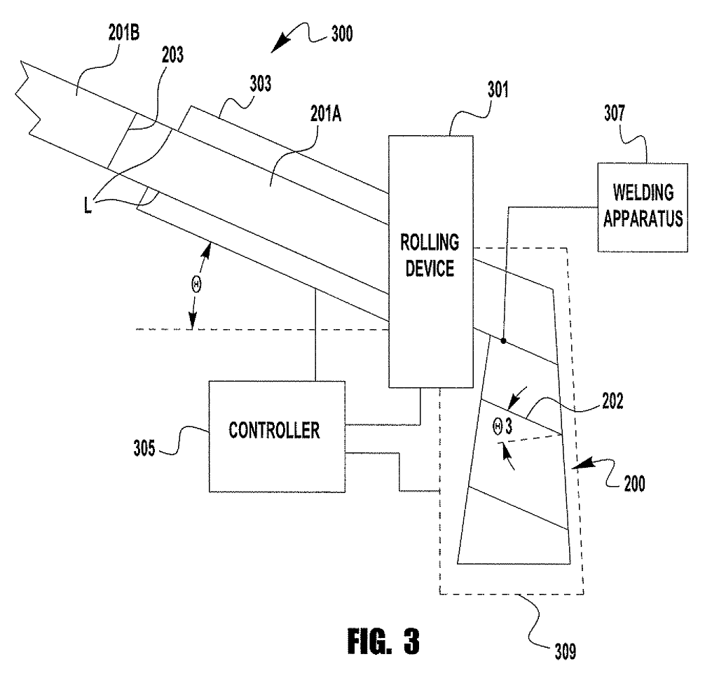

FIGS. 2A through 2C depict various embodiments of a conical tower section 200 made in accordance with various embodiment of the present invention. As shown in FIG. 2A, the conical tower section 200 is manufactured from a single rectangular shaped plate 201 which is continuously rolled in a helical pattern and welded at the seams 202. However, unlike a typical helical pattern, in this embodiment, the angle θ1/θ2 of the seams (relative to the horizontal—as shown by the dashed line) changes along the length of the conical tower section 200. By changing the angle θ1/θ2 along the length, the diameter of the conical tower section 200 changes so as to achieve the conical shape. Thus, at one end of the section 200 the diameter is larger than at the other end. For example, as shown, the bottom end 206 has a larger diameter than the upper end 207. Of course, it is understood that the relative diameters of each end, along with the differences between the diameters, is a function of the design parameters of the section 200.

To manufacture the section 200 (which will be discussed in more detail below) the plate 201 has a generally rectangular shape and a length sufficient to complete the entire height of the section 200. The plate 201 is then continuously rolled at an angle θ1/θ2 as shown such that the angle θ1/θ2 is constantly changing resulting in the overall conical shape of the section 200. During the rolling process, the seam 202 is continuously welded using appropriate welding methodology and techniques. In an embodiment of the invention the angle θ1 is larger (from the horizontal) than the angle θ2. Such an angle differential will cause the diameter of the section 200 to be smaller where the angle θ2 is larger. That is, as the angle θ2 increases relative to angle θ1 the diameter of the section will decrease.

Because of the continuous nature of the above described embodiment, manufacturing of the section 200 is greatly simplified and the time needed is significantly reduced. For example, it is contemplated that the above described embodiment can reduce the manufacture time of a tower section from about one (1) week to a few hours.

In another embodiment of the present invention, the plate 201 used to make the section 200 does not contain a rectangular shape but is made in a trapezoidal type shape having a geometry such that the desired conical shape of the section 200 is achieved without having to effect a change of the orientation of the plate 201 during manufacture. This will be discussed further below.

FIG. 2B depicts a further exemplary embodiment of the present invention. Specifically, as shown in FIG. 2B the section 200 is made from multiple plates 201A and 201B. It is noted that although two (2) plates 201A and 201B are shown, the present invention is not limited to this configuration as it is contemplated that more than two (2) plates can be used. The present invention is not limited in this regard.

In this embodiment, the number of plates used can be a function of the length of the plates available and/or a function of the needed thickness of the plates. For example, because the overall height of the section 200 can be as high as 30 meters (or higher depending on the application) it may be difficult to obtain a single plate 201 having the needed length. Accordingly, multiple plates 201A/201B can be employed with a welded seam 203 to achieve the desired section 200 height.

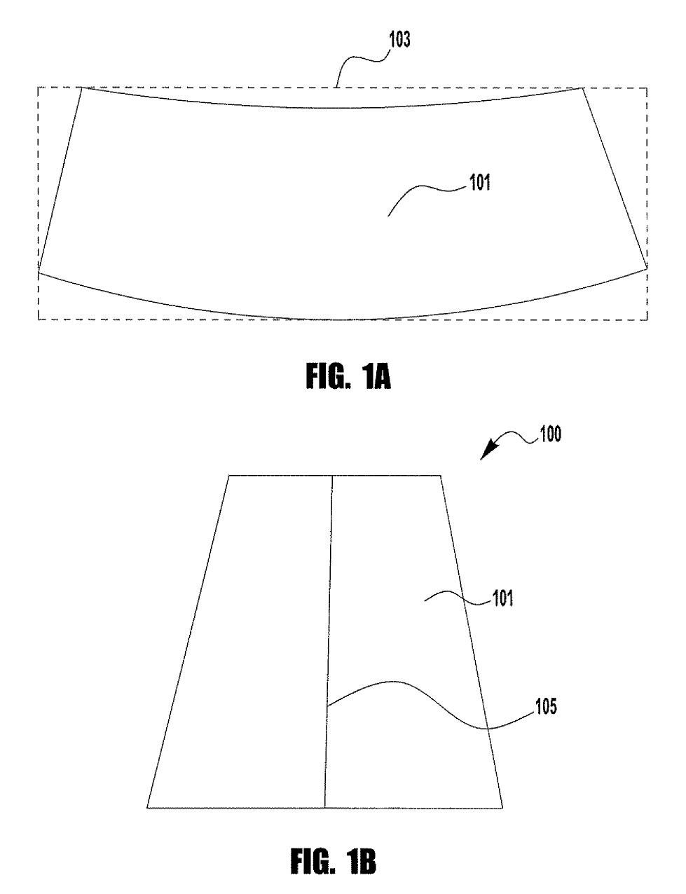

Additionally, as is well known, the structural loads experienced in the plates in the upper portion of a tower are less than those experienced in the plates in the lower portions of the tower. Therefore, the thickness of the plates needed at the bottom of the tower (typically approximately 36 mm) is not needed at the top of the tower, (where typically only about 10 to 12 mm is needed). In existing construction methods (as described with regards to FIGS. 1A and 1B) the conical cans 100 are made of successively thinner plates 101. Accordingly, it is unnecessary and wasteful for the entire tower to be made of the same thickness.

In an embodiment of the present invention, a thicker plate 201A is welded to a thinner plate 201B at a joint 203 to form as single plate structure, such as discussed above with reference to FIG. 2A. This single plate structure can then be rolled and welded as described above to achieve a conical shape. This is depicted in the embodiment shown in FIG. 2B, where thicker plate 201A is welded to thinner plate 201B at the seam 203. The combined plate structure is then rolled to create the conical section 200 as described above. The overall length and relative thickness of each plate section 201A/201B is a function of the required design parameters.

In an alternative embodiment of the present invention, a single plate 201 can be used which varies in thickness along its length. In such an embodiment the desired differential thickness is achieved along the height of a section 200, without the need for joining separate plates 201A/201B.

FIG. 2C is a diagrammatical representation of another embodiment of the present invention, which is similar in structure to that of FIG. 2A except that the upper end 207 of the section 200 is not cut at a horizontal. Instead, end 207 is formed by the end 209 of the plate 201. It is contemplated that the sections 200 of the present invention are secured to other sections using existing methodology, such as using bolt connections (not shown). In such an embodiment, the adjacent section (not shown in FIG. 2C) is configured such that its bottom end interlocks with the plate end 209 and upper end 207 of the previous section, to provide an interlocking type fit between the two sections. In such an embodiment the sections can be secured to each other in any suitable manner, such as welding, bolts, etc.

FIG. 2D diagrammatically depicts a complete conical tower 210 made in accordance with an embodiment of the present invention. As shown, the tower 210 is made up of three sections 200-1, 200-2 and 200-3. However, the present invention is not limited to using three (3) sections to make a tower 210. In fact, it is contemplated that a tower 210 can be made from a single plate 201 (thus a single section) or two sections, or more than three sections. The present invention is not limited in this regard.

As shown in exemplary, non-limiting FIG. 2D, the bottom section 200-1 is made up of a first plate 201A-1 and second plate 201B-1 which are secured to each other at seam 203-1. Here, plate 201A-1 is thicker than plate 201B-1, but can also be of a similar thickness. In another embodiment, as described previously, section 200-1 is made from a single plate having either a constant or varying thickness.

The middle section 200-2 is secured to the bottom section 200-1 at a joint 205 via welding, bolting or any appropriate method. The middle section 200-2 is made up of a first plate 201A-2 and second plate 201B-2 which are secured to each other at seam 203-2. In an embodiment, plate 201A-2 is thicker than plate 201B-2, and plate 201A-2 is thinner than plate 201B-1 from the bottom section 200-1. But, plates 201A-1 ad 201B-2 can also be of similar thickness to each other, and similar thickness or thinner than plate 201B-1. In another embodiment, as described previously, section 200-2 is made from a single plate having either a constant or varying thickness. Section 200-2 may be of similar thickness to, thinner than, section 200-1. Of course, it is also contemplated that Section 200-2 may be thicker than section 200-1, at least in portions thereof to allow for the provision of access doors and the like.

The upper section 200-3 is secured to the middle section 200-2 at a joint 205 via welding, bolting or any appropriate method. The upper section 200-3 is made up of a first plate 201A-3 and second plate 201B-3 which are secured to each other at seam 203-3. In an embodiment, plate 201A-3 is thicker than plate 201B-S3 and plate 201A-3 is thinner than plate 201B-2 from the middle section 200-2. But, plates 201A-3 and 201B-3 can also be of similar thickness to each other, and similar thickness of thinner than plate 201B-2. In another embodiment, as described previously, section 200-3 is made from a single plate having either a constant or varying thickness. Section 200-3 may of similar thickness to, or thinner than, section 200-2.

In another embodiment of the present invention, the entire conical tower 210 is made from a single plate having either uniform or varying thickness. Further, although the joints 205 are depicted with a horizontal based connection as shown, it is contemplated that other joint structure can be used. For example, each section 200-1 and 200-2 may employ a joint configuration as shown at the upper end 207 in FIG. 2C.

Turning now to FIG. 3, this figure depicts a diagrammatical representation of an exemplary embodiment of an apparatus 300 employed to manufacture conical tower sections of the present invention. Of course, the present invention is not limited to the system or methodology set forth in FIG. 3.

Apparatus 300 contains a rolling device 301 which is employed to roll the plate 201A/B to the necessary diameter to create the conical sections as needed. The structure and configuration of the rolling device 301 is consistent with known or existing devices employed to helicoidally roll steel plates, and the like, in industrial applications. Because such devices exist, a detailed discussion of the device 301 or its operation will not be included herein.

Coupled to the rolling device 301 is a platen structure 303. As shown, the platen structure 303 operates as a support or bed for the incoming plate 201A/B which is being fed into the rolling device 301. The structure and/or configuration of the platen 303 is such that it provides adequate support for the plate 201A/B during the rolling process. Existing and/or known platen structures may be employed. Further, because the present invention may employ particularly long plates for manufacture, it is contemplated that the platen structure 303 is of a length longer than is typically known, to provide the sufficient support for the length of the plate 201A/B.

In an embodiment of the present invention, the platen structure 303 is rotatable relative to the rolling structure 301 such that an incoming angle θ of the plate 201A/B is changeable during the rolling process. Thus, during manufacture of a section 200 the angle θ of the platen structure 303 is changed so as to change the angle θ3 of the seam 202, which effects the conical shape of the section 200. In an embodiment of the present invention, the angle θ of the platen is continuously changed during the rolling process so as to effect a continuously changing angle θ3 of the seam 202.

Assuming that the plate longitudinal sides L of the plate 201A/B are parallel to each other, as the angle θ of the platen structure 303 changes, the angle θ3 of the seam changes. Such a change will change the conical shape of the section 200. For example, as the seam angle θ3 increases the diameter of the section 200 will decrease. It is contemplated that this angle change can occur in steps during the rolling process, or continuously, as required by the design parameters of the section 200.

As shown in FIG. 3, the plate to be rolled is made of two plates 201A and 201B joined at seam 203. These plates 201A and 201B can be of the same or different thickness as described previously. Further, these plates can be welded, or otherwise secured to each other at seam 203 while the rolling process is ongoing, or prior to the rolling process. As discussed above, it is contemplated that a single plate or a plurality of plates are rolled to make a section 200.

In an embodiment of the invention, rather than changing the angle of the platen structure 303, the angle of the incoming plate 201A/B is changed relative to the rolling device 301. This can be effected by moving the source (not shown) of the plate 201A/B relative to the platen structure 303 and/or the rolling device 301. For example, the source (not shown) of the plate 201A/B may be a roll of material which is movable relative to the platen structure 303 and or device 301.

In an embodiment of the present invention, as shown, a controller 305 is employed to control the angle θ of the plate 201A/B and/or platen structure 303 during the rolling process. The controller 305 can be a computer device, or the like. In one embodiment, the controller 305 controls the angle automatically based on preprogrammed manufacturing information, and/or feedback regarding the rolling process, and/or feedback regarding the angle of the seam 202, and/or feedback regarding the diameter of the section 200 and/or or other sources. In a further embodiment, the controller 305 may employ manual user inputs to control the angle, or a combination of automated and manual inputs. Because those of ordinary skill in the art are capable of developing a controller capable of effectively implementing the rolling operation of the present invention, a detailed discussion of the controlling mechanism will not be described herein.

In an alternative embodiment of the present invention, rather than changing the angle of the plate 201A/B and/or the platen structure 303 relative to the rolling device 301, the shape of the plate 201A/B is designed such that a conical shape to the section 200 will be achieved by employing a typical rolling process. Such an embodiment requires that the plate 201B be pre-formed to a desired shape to effect the needed conical shape of the section 200.

In a further alternative embodiment, the angle of the section 200 relative to the plate 201A/B being rolled and/or the rolling device 301 is changed rather than changing the angle of the plate 201A/B or platen structure 303 to the rolling device 301. In such an embodiment, the rolling device 301 and platen structure 303 employed can be conventional technologies. The section 200 may be angled during the manufacturing process such that the angle θ'of the seam 202 is changed (either continuously or in steps) during the manufacture of the section 200. The movement/angling of the section 200 during manufacture can be effected by a rotatable and/or movable support structure 309 which supports the section 200 during the manufacturing process.

As with the previously discussed embodiment, a controller 305 can control the movement and/or rotation of the support structure 309 to effect the needed angle change in the seam.

In a further embodiment of the present invention, the controller 305 controls the movement of the platen structure 303, and/or the plate 201A/B, and/or the support structure 309 to control the angle of the seam 202 to obtain the desired conical shape of the section 200. That is, any or all of these three elements can be varied to achieve the desired shape.

As shown in FIG. 3, the seam 202 is welded by a welding apparatus 307. the welding apparatus 307 is any commonly known or used welding apparatus capable of performing the desired welding operation needed for the section 200 being manufactured. It is contemplated that the welding apparatus 307 is either an automated welding apparatus or a manually operated/controlled welding apparatus. The present invention is not limited in this regard.

Because of the benefits of the present invention, where previous methods of manufacturing a conical tower section would take approximately a week, a conical tower section can be manufactured in a few hours.

Whereas the present application describes the present invention in the context of wind power generator towers, the present invention is not limited in this regard. The present invention can be employed in any applications in which a conically shaped structure is to be manufactured, particularly welded steel structures.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A method of manufacturing a conically shaped structure, the method comprising:
providing a plate to a rolling device;
rolling said plate with said rolling device in a helical pattern having seam;
changing an angle of said seam to roll said plate into a conical shape; and
welding said seam.

2. The method of claim 1, further comprising continuously changing the angle of said seam during said rolling step.

3. The method of claim 1, further comprising changing said angle in steps.

4. The method of claim 1, wherein said plate is comprised of a plurality of plates coupled to each other.

5. The method of claim 1, wherein said angle is changed by changing an angle of at least one of said plate during said rolling step, a platen upon which said plate is positioned during said rolling step, a rolling device rolling said plate and a support structure for said rolled plate.

6. The method of claim 1, wherein said plate is rectangular in shape.

7. The method of claim 1, wherein said plate is comprised of at least two plate portions which are coupled to each other, wherein said at least two plate portions have different physical dimensions from each other.

8. The method of claim 1, wherein said plate does not have a uniform thickness.

9. The method of claim 1, wherein said welding of said seam occurs continuously after said rolling step.

10. The method of claim 1, further comprising coupling another plate to said plate during said rolling process.

11. The method of claim 1, wherein said angle is changed because of a shape of said plate.

12. A method of manufacturing a conically shaped structure, the method comprising:
providing a plate to a rolling device;
rolling said plate with said rolling device in a helical pattern having seam;
changing an angle of said seam to roll said plate into a conical shape; and
welding said seam,
wherein said angle is change continuously during said rolling step.

13. The method of claim 12, wherein said plate is comprised of a plurality of plates coupled to each other.

14. The method of claim 12, wherein said angle is changed by changing an angle of at least one of said plate during said rolling step, a platen upon which said plate is positioned during said rolling step, a rolling device rolling said plate and a support structure for said rolled plate.

15. The method of claim 12, wherein said plate is rectangular in shape.

16. The method of claim 12, wherein said plate is comprised of at least two plate portions which are coupled to each other, wherein said at least two plate portions have different physical dimensions from each other.

17. The method of claim 12, wherein said plate does not have a uniform thickness.

18. The method of claim 12, wherein said welding of said seam occurs continuously after said rolling step.

19. The method of claim 12, further comprising coupling another plate to said plate during said rolling process.

20. The method of claim 12, wherein said angle is changed because of a shape of said plate.
